(19) United States
(12) Patent Application Publication
(10) Pub. No.: US 2005/0165616 A1
(43) Pub. Date: Jul. 28, 2005

(54) System and method for personnel accountability recording

(75) Inventors: John Clemens Ellis, Chesterfield Township, MI (US); Filippo Mike Biundo, Chesterfield Township, MI (US)

Correspondence Address: JAMES HARLAN, 28054 LANDOWNE DR., HARRISON TOWNSHIP, MI, 48045, US

(73) Assignee: Incident Command Technologies, Inc.

(21) Appl. No.: 10/763,739

(22) Filed: Jan. 26, 2004

(51) Int. Cl. G06F 17/60

(52) U.S. Cl. 705/1

(57) ABSTRACT

Method and system are provided for personnel accountability recording. More specifically, the present invention provides methods and system for accounting for fire fighters at an emergency incident. Each instance of a fire fighter assigned to a staging area, or to a command position, is time-stamped for later retrieval and review. Additionally, should an on-scene emergency be called, the disclosed invention will notify others of the location of the injured.

### CROSS-REFERENCE TO RELATED APPLICATIONS

This application claims priority under 36 U.S.C. § 119(e) from the U.S. Provisional Application No. 60/440,736, filed Jan. 17, 2003, entitled “SYSTEM AND METHOD FOR TRACKING PEOPLE.” The entire disclosure of said Provisional Application is hereby incorporated by reference.

### BACKGROUND OF THE INVENTION

The National Fire Protection Association (NFPA) under Standard NFPA 1500, Standard on Fire Department Occupational Safety and Health Program, Chapter 8, Section 3 requires that Fire Departments establish written Standard Operating Procedures for a personnel accountability system. Fire Departments are required to track their personnel at emergency incidents, commonly known as a “scene.”

Current manual personnel accountability systems consist of the use of personal identification tags and manual (pen and paper or wax pen and lexan) documentation of fire fighter's assignments and locations. Due to the fact that firefighter assignments and locations are dynamic, tracking their assignments and whereabouts in a timely and accurate manner is a monumental task. Although the use of personal identification tags by fire fighters helps put the fire fighter on the scene, but they do not, however, provide for a detailed and accurate tracking of the fire fighter throughout the entire scene. A situation could arise where a fire fighter requests a Mayday, and the manual personnel accountability system have that fire fighter's assignment and/or location noted incorrectly. Use of the manual personnel accountability systems as described above is terribly inefficient and unsafe.

### SUMMARY OF THE INVENTION

Fire Departments using an electronic personnel accountability recorder (PAR) system will benefit in four major ways. First, PAR will allow them to make (and track) a fire fighter's assignment dynamically, with the touch of the screen. PAR lists the assignment given, the location where the assignment is being performed and the time the assignment was made. This addresses a huge safety issue, by providing Fire Departments with the information they need to constantly know where their firefighters are and what they are doing. Second, it is critical that personnel accountability systems be easy to use on scene. This critical task of tracking personnel on scene cannot be hampered or interfered with due to hard to use or inefficient and unsafe applications. Things happen quickly on scene, and personnel accountability has quickly respond.

Third, PAR will provide a detailed, accurate, written chronological report on what happened on scene. After a fire, Fire Departments conduct Post Incident Analysis (PIA's-NFPA 1500-8.8) to critique the emergency incident and how it was handled. By having detailed and chronological information, the PIA's will be much more accurate and productive—shortcomings will be identified so that they can be corrected. And finally through the use of PAR, firefighters will be able to identify what specific areas need improvement and can conduct training in those areas to improve their services, thereby reducing risk of harm, loss of life, and property due to fire.

### BRIEF DESCRIPTION OF THE FIGURES

The preferred embodiment will now be describe, by way of example, with reference to the accompanying drawings, in which:

FIG. 1 is a view of the PAR Home Page as displayed on a handheld computer;

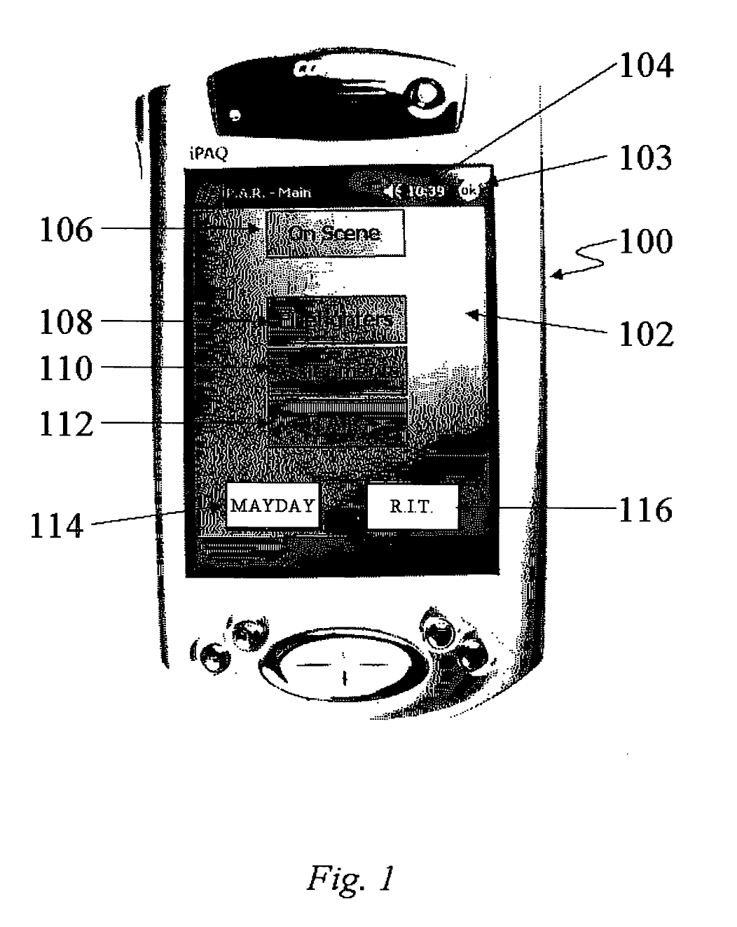

FIG. 2 is a view of the PAR Home Page as displayed on a handheld computer after an incident has begun;

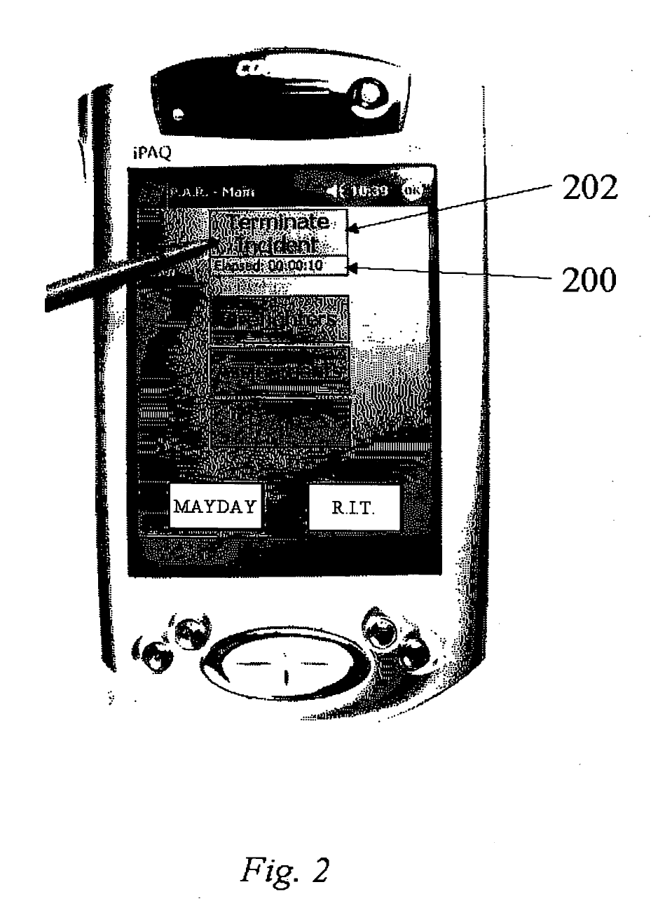

FIG. 3 is a view of the PAR Home Page as displayed on a handheld computer requesting the termination of an incident;

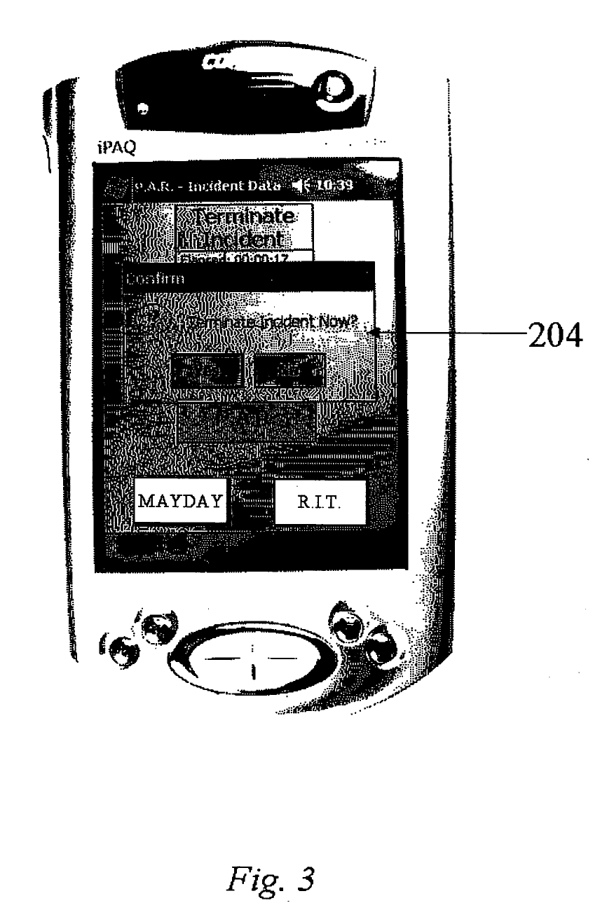

FIG. 4 is a view of a list of firefighters as displayed on a handheld computer;

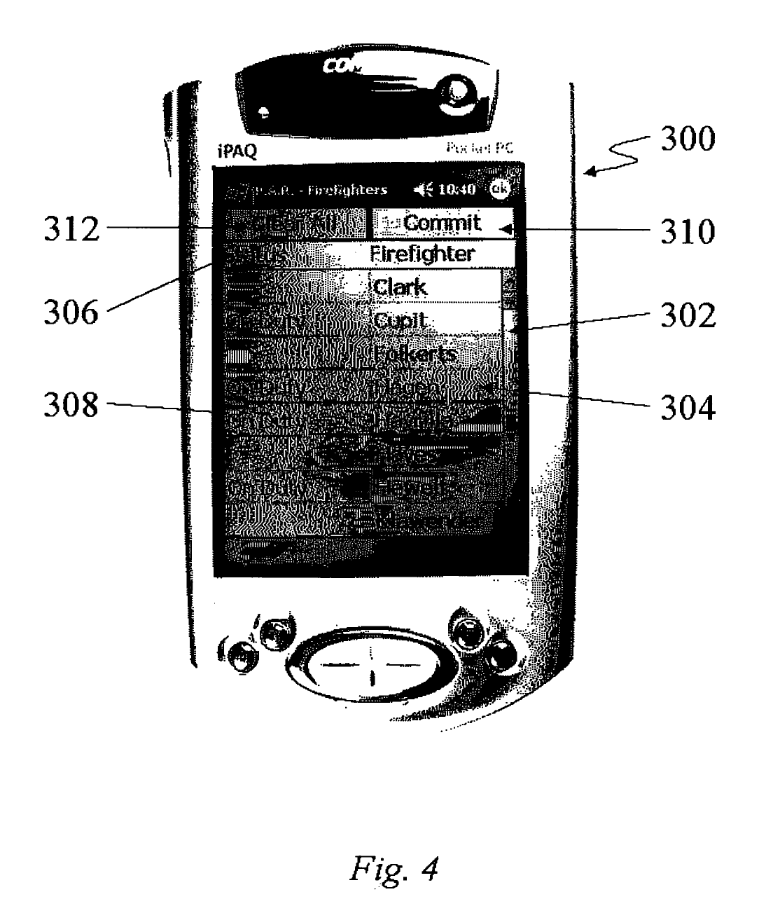

FIG. 5 is a view of a list of Officer Assignments as displayed on a handheld computer;

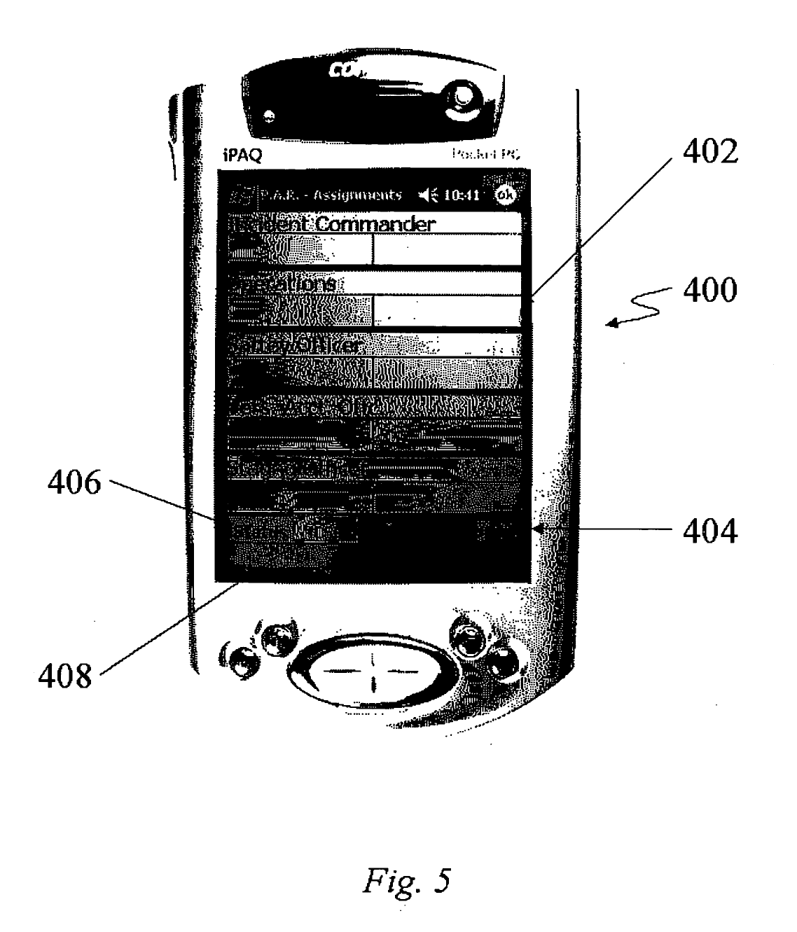

FIG. 6 is a view of a Status List as displayed on a handheld computer;

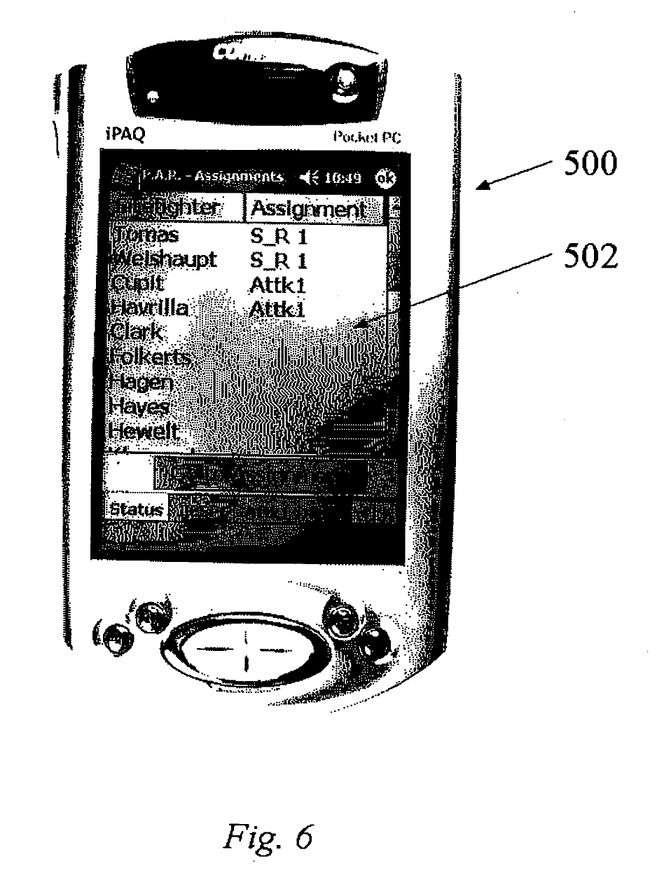

FIG. 7 is a view of a list of Officer Assignments as displayed on a handheld computer;

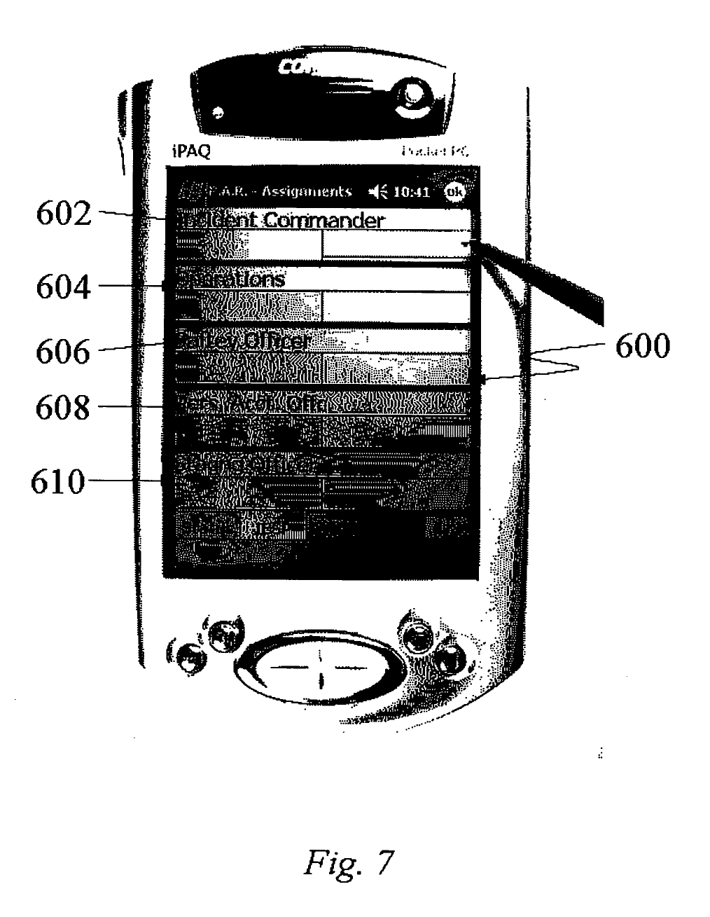

FIG. 8 is a view of a list of Officer Assignments as displayed on a handheld computer with a Firefighter drop-down;

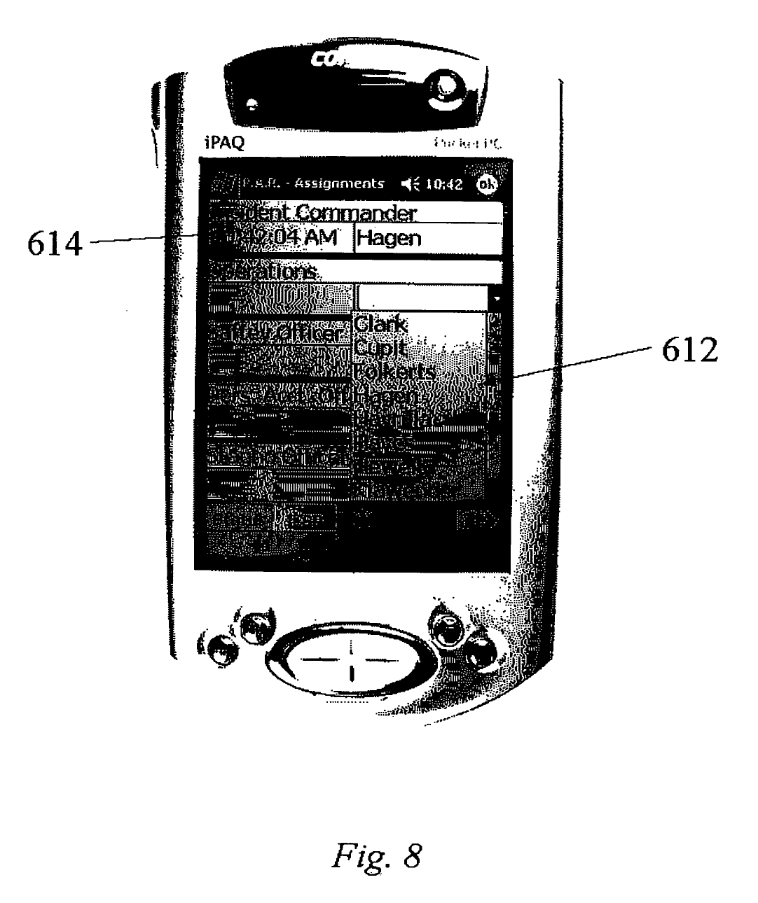

FIG. 9 is a view of a Fire Attack Assignment as displayed on a handheld computer;

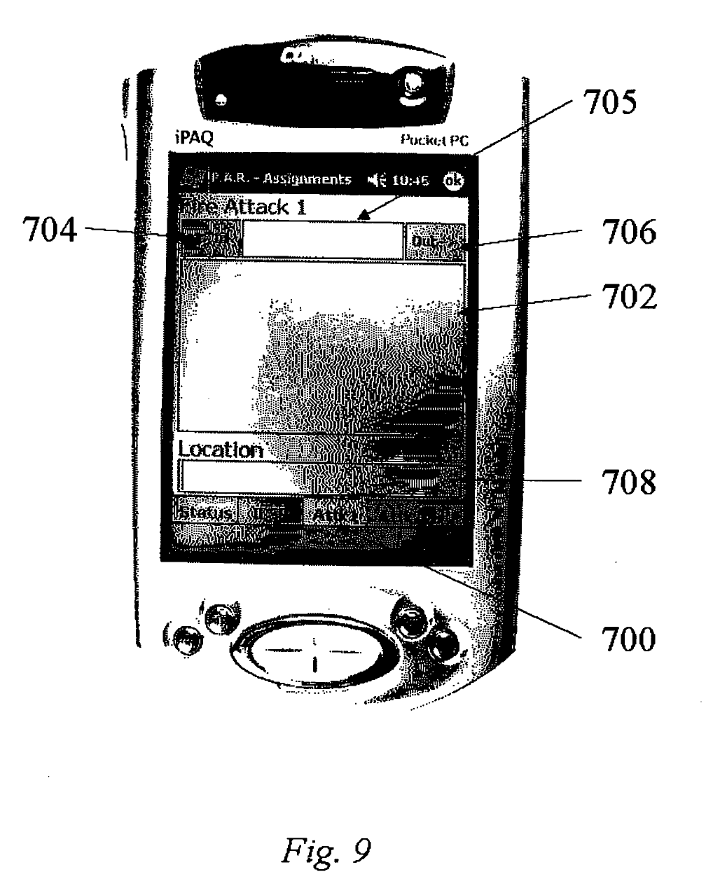

FIG. 10 is a view of a Fire Attack Assignment as displayed on a handheld computer with a location list displayed; and

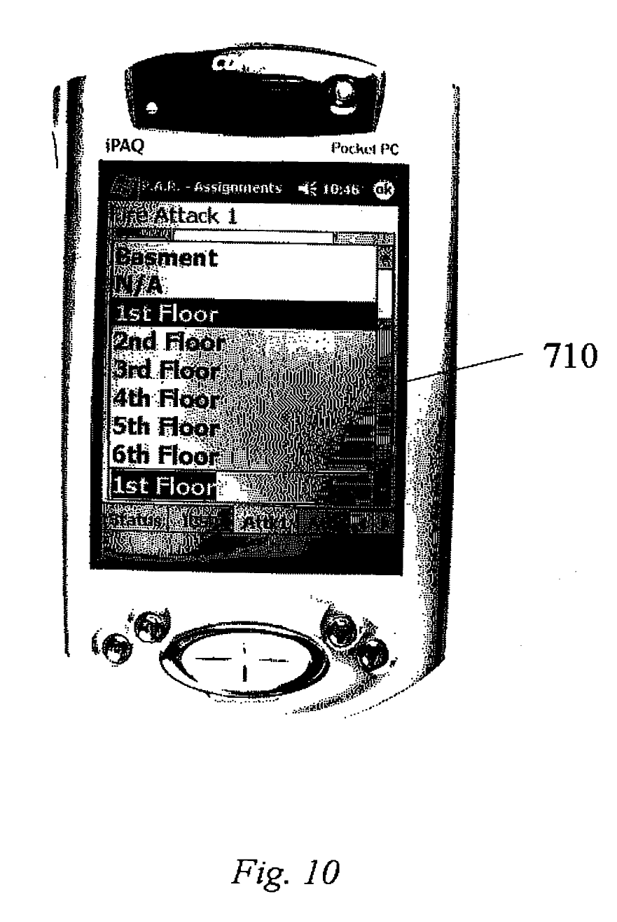

FIG. 11 is a view a P.A.R. log as displayed on a handheld computer.

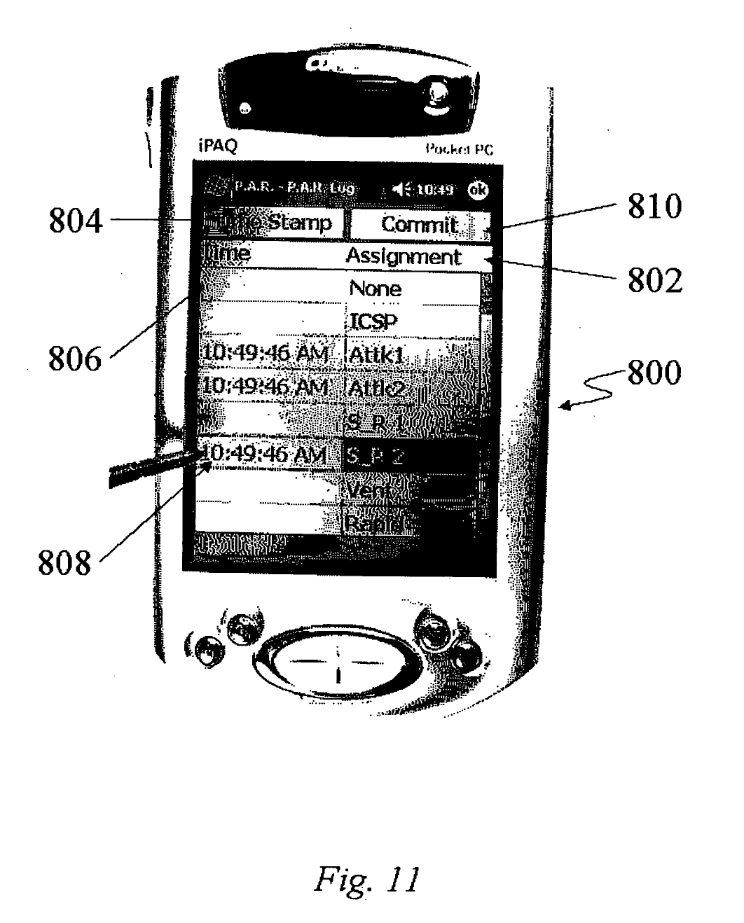

### DESCRIPTION OF THE PREFERRED EMBODIMENT

It is to be understood that the present invention may be implemented in various forms of hardware, software, firmware, special purpose processors, or a combination thereof. Preferably, the present invention is implemented as a combination of hardware and software, the software being an application program tangibly embodied on a program storage device. The application program may be uploaded to, and executed by, a machine comprising any suitable architecture. The machine may be implemented on a computer platform having hardware such as one or more central processing units (CPU), a random access memory (RAM), and input/output (I/O) interface(s). The computer platform may also include an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device.

It is to be further understood that, because some of the constituent system components depicted in the accompanying Figures may be implemented in software, the actual connections between the system components may differ depending upon the manner in which the present invention is programmed. Given the teachings herein, one of ordinary skill in the related art will be able to contemplate these and similar implementations or configurations of the present invention.

Referring to the Figures wherein like numerals indicate like or corresponding parts throughout the several views. As noted above, the preferred embodiment is directed to a personnel accountability system executed on a portable computer, generally shown at 100, preferably a handheld computer with a touch screen for input. It is desirable to surround the handheld computer with a durable material wherein the durable material is rugged and/or water resistant sufficient to protect the handheld computer from a harsh environment where a plurality of emergency personnel might work. One example of an emergency personnel is a fire fighter, and is the personnel preferred in the primary embodiment. But it is understood that a police officer, emergency worker, soldier, or relief worker, for example, could satisfy the definition of emergency personnel.

At the start of an emergency incident, or scene, a user begins the disclosed invention, wherein the user can be an incident commander, a Personnel Accountability Officer (PAO), or some other person, for example, at which point the Home Page 102 displays a plurality of buttons 106, 108, 110, 112, 114, 116. The buttons 106, 108, 110, 112, 114, 116 are regions of the handheld computer that are sensitive to a touch pressure so as to execute the software code associated with each button 106, 108, 110, 112, 114, 116. The Home Page 102 shows a system time 104, an On Scene button 106, a Fire fighters button 108, an Assignments button 110, a P.A.R. button 112, a Mayday button 114, and an R.I.T. button 116. The system time 104 may be derived from the portable computer's internal clock, or radio synchronized with an atomic clock, for example. The user will select the On Scene button 106 and an incident clock 200 will initialize with a scene time value (not depicted) that is electronically communicated from the system clock 104. The incident clock 200 provides continuous scene time as required by NFPA 1500, Chapter 8, section 8.1.12.1 Once the On Scene button 106 is initially selected and the incident clock 200 begins to run, the On Scene button 106 then changes to a Terminate Incident button 202. And the user can return to the Home Page 102 from anywhere in the application by selecting an “OK” button 103.

When pressing the Firefighter button 108 you go to a fire fighter screen, generally shown at 300, with a fire fighter list 302 with a plurality of fire fighters 304 available for the emergency incident, for example those fire fighters in a Fire Department, but could also be any personnel utilized in an emergency. On the fire fighter screen 300, there is an option for selecting the names of the fire fighters by status 306, wherein status is on duty, part time, or off duty for example. If it is desired to only have the names of the firefighters working (or “on-duty”) on a particular day available for selection, the user can select the fire fighter's name 304 from the firefighter list 302, and an On-Duty tag 308 will appear in the box next to the selected firefighter name 304. Selecting a “Commit” button 310 will filter the firefighter names 304, so that only the fire fighters with the “On-duty” tag 308 will be available in future firefighter selections. Pressing a “Clear All” button 212 clears all status 306 selections.

Pressing the “Assignment” button 110 executes an assignment page, generally shown at 400, that displays a plurality of assignments identified by a plurality of tabs, generally shown at 404, at the bottom of the assignment page 400. Each assignment tab 404 displays a corresponding page 402 on the assignment page 400 in a region above the assignment tabs 404. Because of differences in terminology from one area of the country to another, the PAR software has been developed so that the user will have the ability to customize the name of each assignment 404.

An Incident Command tab 408 displays a Command page, generally shown at 600, and lists a plurality of Command-level (i.e., Management) personnel. In this area, terminology is consistent because the National Fire Academy has mandated that Fire Departments in the United States operate under the Incident Command System, and its components are “universal.” The user makes a Command assignment on the Command page 600, for an Incident Commander 602, an Operations Officer 604, a Safety Officer 606, a Personnel Accountability Officer 608, and a Staging Officer 610. The Command assignment is made by touching the right hand corner of the pull down menu box with the stylus. This will cause the fire fighters list, or filtered fire fighters, to display in a drop-down list 612. The user then selects the name for the command assignment and the fire fighter's name is highlighted and then inserted into the command assignment space. At the time of name insertion, it is also time stamped from the scene time value, and placed in a time stamp location 614.

The Assignment tabs 404 may be customized by the user by methods commonly understood by those skilled in the art, but commonly will be referred to as (Fire) Attack 1, (Fire) Attack 2, Suppression, Attack Back-Up, Primary Search, Secondary Search, Ventilation, Rapid Intervention (OSHA Mandate), Firefighter Rehab(ilitation), Staging, etc. The steps needed to add the fire fighter into and out from the assignment, are the same for any of the above assignments. Using the Fire Attack 1 tab for illustration, after pressing a Attk1 tab 700, a Fire Attack 1 page 702 appears. On the Fire Attack 1 page 702 will appear an In box 704, a Time box 705, an Out box 706 and a Location box 708. It is preferable to choose a location in the location box 708 to place the fire fighter and a known location. The user will select the In box 704 to make the assignment and the fire fighters' names (all of them, unless names were filtered, and then only the On-Duty names will appear) will appear in a drop-down list. The user selects at least two name(s) to assign and they are highlighted. The user then selects “OK” and the fire fighters are assigned to the assignment. The user then touches the right side of the Location box 708 and a plurality of locations 710 appear in a location drop-down list. (For example basement, 1^{st} floor, 2^{nd} floor, 3^{rd} floor, 4^{th} floor, roof, garage, etc) The locations 710 could depend on tallest building in a City, for example, and is customizable by the user. The location 710 is then selected and the assignment is time stamped based upon the scene time, and placed in the Time box 705.

To move the firefighter out of the assignment, the firefighter's name is selected. The user then selects the Out box 706 and a reassign dialogue box (not depicted) displays “Reassign firefighter to ?” In the reassign dialogue box, the other user-defined assignments (as listed above) are displayed and the user selects the assignment where he/she is sending that particular firefighter, for example Rehab, Staging, etc. Each move that is made is time stamped based upon the scene time. When selecting a Status tab 406, PAR displays a Status page, generally shown at 500, with the names of every On Duty fire fighter 502, as previously discussed. As different assignments are made, that information will be recorded to the Status page 500. When the user accesses the Status page 500, PAR will scan (and update) the assignments and then list the fire fighters assigned the their respective locations.

Also on the Home Page 102 the user has access to a plurality of single-purpose emergency buttons. An example of the single-purpose emergency button is the R.I.T. button 116. R.I.T. stands for Rapid Intervention Team (also known as Rapid Intervention Crews (RIC's) or other terms as understood in the industry) and fire fighters are assigned to an R.I.T. assignment from the assignment page 400, as previously discussed. Although R.I.T. is assigned, they are a team that is on “stand-by,” ready to respond to a call from a fire fighter in need of help. The R.I.T. assignment is an OSHA mandated assignment that must be filled (Referred to as the Two-In, Two-Out Rule). A time-stamp is assigned to the deployment of the R.I.T. assignment. It is an important feature of the preferred embodiment to document when this team is deployed. Also, it is critical that the R.I.T. assignment be re-filled with new fire fighters. There always has to be a team on stand-by to assist other fire fighters. If the fire fighters assigned to the R.I.T. assignment are busy, the user must reassign other fire fighters to another R.I.T. assignment in case of another call for help. When the R.I.T. button is activated, a R.I.T. dialogue box (not depicted) will appear stating “RIT deployed to” and the assignment list 502 will be displayed to the user. Based on who has called for help, the user selects the assignment calling for help and PAR goes to that assignment, showing the firefighters involved and their current location.

Another single-purpose emergency button is the “MAYDAY” button 114. Firefighters are trained to call-in a MAYDAY by methods understood in the industry (e.g. radio, cellular telephone, and walkie-talkies) for cases where he/she is lost, trapped, injured, etc. When the MAYDAY is called, the user selects the “MAYDAY” button 104 and a MAYDAY dialogue box (not depicted) appears stating “MAYDAY called by:” and the assignment list 502 is displayed. The user selects the fire fighter that called the MAYDAY and PAR displays to the user the assignment showing the fire fighters involved and their current location. And again, a time-stamp is associated with the MAYDAY call, based on scene time.

The last button on the Home Page 102 is the P.A.R. button 112. P.A.R. in this case stands for Personnel Accountability Report. Depending on the Fire Department policy, Fire Departments are required to record a personnel accountability report, which is actual contact with every assignment to insure their safe status at periodic intervals (e.g. 15, 20, 25, or 30 minutes), after which time the Fire Department's P.A.R. requirement is met. The P.A.R. button 112 has an audible or visual alarm that can be set by the user to activate at any of the above time intervals to remind the Personnel Accountability Officer (PAO) that a P.A.R. is due. Accordingly, the alarm will remain active until the user has satisfied the P.A.R. Often, during an emergency incident it is easy to lose track of time. NFPA 1500 8.1.12 requires a Dispatch keep this “incident clock,” however, even the Dispatch gets overloaded during emergencies and can lose track of time. The PAO will select the button and it will take him/her to a P.A.R. page 800. On the P.A.R. page 800 is a list of all assignments 802. The user will select a “Time stamp” button 804 and will touch a time box 806, for example, next to the assignments 802. At which time, the P.A.R. is time stamped with a scene time value in a P.A.R. Time box 808. Commit button 810 is pressed, the time-stamped information is saved along with the corresponding assignment 802. This insures accurate documentation of PAR for each assignment.

Once the incident has ended you return to the Home Page 102 and select the Terminate Incident button 202. When the “Terminate Incident” button 202 is selected, the application displays a Save screen (not depicted). However, if the user accidentally presses the Terminate Incident button 202 before actual termination of the emergency incident, a termination confirmation window 204 appears asking to verify this decision. The termination confirmation window 204 is a safety feature to prevent premature termination of the personnel accountability recording software that is tracking the emergency incident. On top of the Save screen is a run number box (not depicted) to enter the individual department's run number (each fire department will use specific numbers to identify an incident). Below the run number box is an incident date box (not depicted) to enter the date the incident occurred. Below the incident date box is a note box (not depicted) for the user to enter any notes. The user selects a Save button to save the information to the portable computer in a method commonly known and understood. The application returns the user to the Home Page 102. An exit confirmation box then appears asking the user if he/she wishes to close the application. Selecting “YES” closes the application, while selecting “NO” does not.

The portable computer can then be put in a cradle or dock, or by some other method to transmit date, to synchronize the entire report to a desktop computer for printing and/or display.

The above-described embodiment was chosen for purposes of describing but one application of the disclosed invention. It will be understood by those who practice the invention and by those skilled in the art that various modifications and improvements may be made to the invention without departing from the spirit of the disclosed concept.

1. A computer-readable medium containing a program for personnel accountability recording comprising steps including:
initiating an incident clock wherein said incident clock obtains a scene value time from a system clock that sequentially inscribes a plurality of time-stamps in a forward-linear manner;
displaying a personnel list of a plurality of personnel;
associating at least one event with at least one time-stamp;
providing at least one single-purpose emergency buttons;
assigning to at least one recording list at least one of said time-stamps to at least one of said events whereby said event contains at least one of said personnel from said personnel list; and
reporting at least one of said recording lists.

2. The computer-readable medium as recited in claim 1, wherein the program is electronically stored on a portable device.

3. The computer-readable medium as recited in claim 2, wherein the portable device is encased in a durable material.

4. The computer-readable medium as recited in claim 1, wherein the personnel list is a customizable list of at least one name that can be filtered into an On-Duty roster wherein said On-Duty roster is a filtered list of the personnel.

5. The computer-readable medium as recited in claim 1, wherein the event is a command position selection whereby at least one of said personnel is selected to a plurality of command positions, and associating said time-stamp with said command position selection.

6. The computer-readable medium as recited in claim 1, wherein the event is a personnel assignment selection, wherein at least one of said personnel less the personnel classified in the command positions is selected to a plurality of assignments, associating said time-stamp with said personnel assignment selection, and placing said personnel in an assignment location.

7. The computer-readable medium as recited in claim 1, wherein said single-purpose emergency button displays a plurality of personnel assigned to a secondary response team, wherein said single-purpose emergency button records with said time-stamp when at least one of personnel require emergency help.

8. The computer-readable medium as recited in claim 1, wherein said recording list is electronically associated to a sensory indicator that alerts a user at a set time intervals to associate said assignment list with said time-stamp.

9. The computer-readable medium as recited in claim 1, wherein said program provides a document and control system.

10. A method for personnel accountability recording by a program on a portable device comprising the steps of:
initiating an incident clock wherein said incident clock obtains a scene value time from a system clock that sequentially inscribes a plurality of time-stamps in a forward-linear manner;
displaying a personnel list of a plurality of personnel;
associating at least one event with at least one time-stamp;
providing at least one single-purpose emergency buttons;
assigning to at least one recording list at least one of said time-stamps to at least one of said events whereby said event contains at least one of said personnel from said personnel list; and
reporting at least one of said recording lists.

11. The method as recited in claim 10, wherein the portable device is encased in a durable material.

12. The method as recited in claim 10, wherein the personnel list is a customizable list of at least one name that can be filtered into an On-Duty roster wherein said On-Duty roster is a filtered list of the personnel.

13. The method as recited in claim 10, wherein the event is a command position selection whereby at least one of said personnel is selected to a plurality of command positions, and associating said time-stamp with said command position selection.

14. The method as recited in claim 10, wherein the event is a personnel assignment selection, wherein at least one of said personnel less the personnel classified in the command positions is selected to a plurality of assignments, associating said time-stamp with said personnel assignment selection, and placing said personnel in an assignment location.

15. The method as recited in claim 10, wherein said single-purpose emergency button displays a plurality of personnel assigned to a secondary response team, wherein said single-purpose emergency button records with said time-stamp when at least one of personnel require emergency help.

16. The method as recited in claim 10, wherein said recording list is electronically associated to a sensory indicator that alerts a user at a set time intervals to associate said assignment list with said time-stamp.

17. The method as recited in claim 10, wherein said program provides a document and control system.

18. In an emergency environment wherein an incident commander arrives at an emergency scene and utilizes a handheld device with a touch sensitive display, wherein said handheld device is encased in a durable material, a method for tracking a plurality of fire fighters comprising the steps of:
a. initiating an incident clock wherein said incident clock obtains a scene value time from a system clock that sequentially inscribes a plurality of time-stamps in a forward-linear manner;
b. displaying a fire fighter list of a plurality of fire fighters;
c. classifying a plurality of command positions from a selection of at least one fire fighter from the fire fighter list and identifying the time of said classification with said associated time-stamp;
d. associating a plurality of assignments from a selection of at least one fire fighter from the fire fighter list less the fire fighters classified in the command positions, identifying an association time based on said time-stamp, and placing said fire fighters in an assignment location;
e. assigning to at least one recording list at least one of said time stamps to at least one of said events whereby said event contains at least one of said fire fighters from said fire fighter list;
f. providing at least one single-purpose emergency buttons, wherein said single-purpose emergency button displays a plurality of fire fighters assigned to a secondary response team, and records with the time-stamp when at least one fire fighter requires emergency help; and
g. reporting at least one of said recording lists based on a sensory indicator that alerts a user at a set time intervals to associate said assignment list with said time-stamp

19. The method as recited in claim 18, wherein the fire-fighter list is a customizable list of at least one name that can be filtered into an On-Duty roster wherein the On-Duty roster lists fewer and more relevant fire fighters.

20. The method as recited in claim 18, wherein said program provides a document and control system.
